(19) United States
(12) Patent Application Publication
(10) Pub. No.: US 2026/0202242 A1
(43) Pub. Date: Jul. 16, 2026

(54) PHOTODETECTOR WITH TAPERED SUBSTRATE

(71) Applicant: Cisco Technology, Inc., San Jose, CA (US)

(72) Inventors: Jean-Luc J. TAMBASCO, Macungie, PA (US); Rajat SHARMA, Pasadena, CA (US)

(21) Appl. No.: 19/021,117

(22) Filed: Jan. 14, 2025

(51) Int. Cl. G01J 1/02; G01J 1/04

(52) U.S. Cl. CPC G01J 1/0209; G01J 1/0488

(57) ABSTRACT

The present disclosure describes an optical system that includes a photodetector with a tapered substrate. The optical system includes a first optical device, a substrate, and an absorption region. The first optical device produces a first optical signal based on a first input optical signal and a second input optical signal. The substrate includes a first portion and a second portion. The first portion includes a first tapered edge that directs the first optical signal to the second portion. The absorption region is positioned on the second portion of the substrate. The absorption region produces a first electrical signal based on the first optical signal.

### TECHNICAL FIELD

Embodiments presented in this disclosure generally relate to optical systems. More specifically, embodiments disclosed herein relate to a photodetector with a tapered substrate.

### BACKGROUND

Photodetectors are used in optical systems to convert optical signals into electrical signals. The photodetectors include an absorption region that absorbs the optical signals and produces electrical signals. Existing photodetectors, however, may not be designed to satisfy the higher bandwidth needs of ever increasing communication speeds.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates an example system.

FIG. 2 illustrates an example optical device in the system of FIG. 1.

FIG. 3 illustrates an example photodetector in the system of FIG. 1.

FIG. 4 illustrates an example configuration of the system of FIG. 1.

FIG. 5 illustrates an example configuration of the system of FIG. 1.

FIG. 6 illustrates an example configuration of the system of FIG. 1.

FIG. 7 illustrates an example configuration of the system of FIG. 1.

FIG. 8 illustrates an example configuration of the system of FIG. 1.

FIG. 9 illustrates an example configuration of the system of FIG. 1.

FIG. 10 illustrates an example configuration of the system of FIG. 1.

FIG. 11 illustrates an example configuration of the system of FIG. 1.

FIG. 12 illustrates an example configuration of the system of FIG. 1.

FIG. 13 illustrates an example configuration of the system of FIG. 1.

FIG. 14 is a flowchart of an example method performed by the system of FIG. 1.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### OVERVIEW

The present disclosure describes an optical system that includes a photodetector with a tapered substrate. According to an embodiment, an optical system includes a first optical device, a substrate, and an absorption region. The first optical device produces a first optical signal based on a first input optical signal and a second input optical signal. The substrate includes a first portion and a second portion. The first portion includes a first tapered edge that directs the first optical signal to the second portion. The absorption region is positioned on the second portion of the substrate. The absorption region produces a first electrical signal based on the first optical signal.

According to another embodiment, a method includes producing, by a first optical device, a first optical signal based on a first input optical signal and a second input optical signal and directing, by a first tapered edge of a first portion of a substrate, the first optical signal to a second portion of the substrate. The method also includes producing, by an absorption region positioned on the second portion of the substrate, a first electrical signal based on the first optical signal.

According to another embodiment, an optical system includes an optical multiplexer and a photodetector. The optical multiplexer produces an optical signal based on a first input optical signal and a second input optical signal. The photodetector includes a substrate and an absorption region. The substrate includes a first portion and a second portion. The first portion includes a first tapered edge that directs the optical signal to the second portion. The absorption region is positioned on the second portion of the substrate. The absorption region produces a first electrical signal based on the optical signal.

### EXAMPLE EMBODIMENTS

The present disclosure describes an optical system that includes a photodetector (e.g., a germanium photodetector or germanium photodiode). The photodetector includes a substrate and an absorption region positioned on the substrate. The substrate includes a tapered edge that directs optical signals towards the absorption region, which may be rectangular in shape. The optical signals enter the absorption region across a length of the absorption region, which may be longer than the width of the absorption region. The absorption region then produces an electrical signal based on the optical signal.

In particular embodiments, the optical system provides several technical advantages. For example, the optical system provides higher bandwidth and communication speeds relative to existing optical systems. As another example, the optical system provides improved responsivity, return loss, and/or power handling relative to existing optical systems.

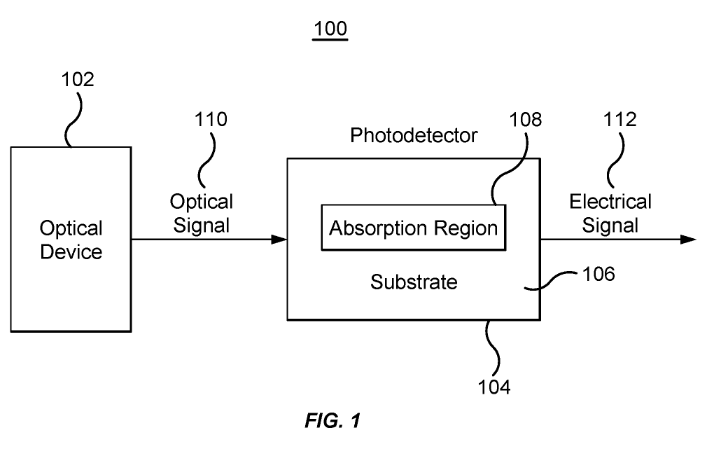

FIG. 1 illustrates an example system 100, which may be an optical system that is used for optical communications. As seen in FIG. 1, the system 100 includes an optical device 102 and a photodetector 104. Generally, the optical device 102 directs an optical signal to the photodetector 104, and the photodetector 104 produces an electrical signal based on the optical signal.

The optical device 102 may be any device that produces and directs an optical signal to the photodetector 104. The optical device 102 may receive two input optical signals and may produce an optical signal using the two input optical signals. In some embodiments, the optical device 102 is a two-mode multiplexer. In certain embodiments, the optical device 102 is a two-mode y (e.g., a two-mode y optical splitter), which may be an optical device that uses a Y-junction design that handles or manipulates two optical modes simultaneously. In particular embodiments, the optical device 102 is a polarization splitter rotator.

The photodetector 104 uses the optical signal from the optical device 102 to produce an electrical signal. As seen in FIG. 1, the photodetector 104 includes a substrate 106 and an absorption region 108. The absorption region 108 may be positioned on the substrate 106. In some embodiments, the absorption region 108 includes a germanium junction region that absorbs optical signals and produces electrical signals. The shapes and arrangement of the substrate 106 and the absorption region 108 may be set to increase bandwidth and to mitigate return loss, in certain embodiments.

In operation, the optical device 102 directs an optical signal 110 to the photodetector 104. The optical signal 110 may enter the substrate 106, and the substrate 106 may direct the optical signal 110 to the absorption region 108. The optical signal 110 may generate electron-hole pairs in the absorption region 108. The electrons and holes are separated, which causes the absorption region 108 to produce an electrical signal 112 (which may be an electrical current). The magnitude of the electrical signal 112 may be proportional to the intensity of the optical signal 110.

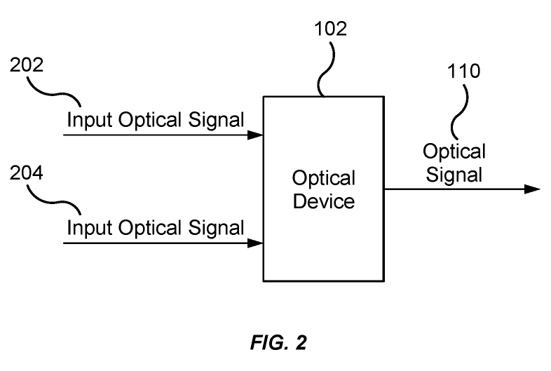

FIG. 2 illustrates an example optical device 102 in the system 100 of FIG. 1. As seen in FIG. 2, the optical device 102 receives an input optical signal 202 and an input optical signal 204. The input optical signals 202 and 204 may have different optical modes. The optical device 102 produces the optical signal 110 using the input optical signals 202 and 204. Generally, the optical signal 110 may include both optical modes of the input optical signals 202 and 204. In some instances, the optical device 102 may preserve the optical modes of the input optical signals 202 and 204 in the optical signal 110 with minimal or no loss of optical power.

As discussed above, the optical device 102 may be one of several different types of optical devices. For example, the optical device 102 may be a two-mode multiplexer that combines two optical modes of the input optical signals 202 and 204 onto a single waveguide. The two optical modes may propagate through the waveguide as distinct modes in the optical signal 110. As another example, the optical device 102 may be a two-mode y optical device that uses a Y-junction to split and recombine each input optical signal 202 or 204 in two different modes. As another example, the optical device 102 may be a polarization splitter rotator that splits the input optical signals 202 and 204 based on polarization state and rotates the polarization.

In some embodiments where the optical device 102 is a two-mode multiplexer, the optical device 102 may provide about 0.05 decibels (dB) of insertion loss and a crosstalk of better than 30 dB. Additionally, the optical device 102 may have a length of about 60 micrometers (µm). In certain embodiments where the optical device 102 is a two-mode y (e.g., two-mode y optical splitter), the optical device 102 may have a length of about 20 µm, which may provide a more compact adiabatic design relative to other optical devices. In particular embodiments where the optical device 102 is a polarization splitter rotator, the optical device 102 produces transverse electric and transverse magnetic modes, which may be suitable for transverse magnetic launched photodetectors or thicker silicon platforms.

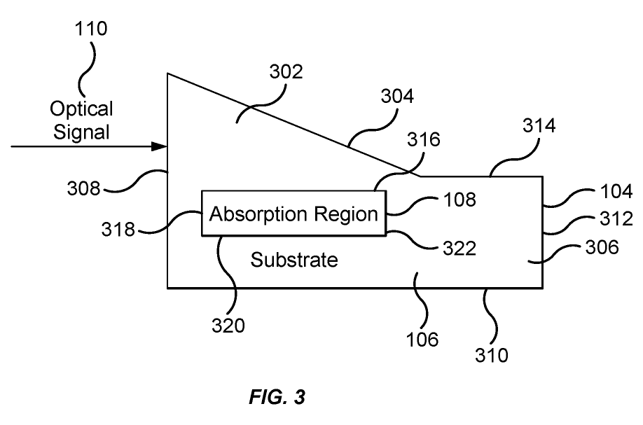

FIG. 3 illustrates an example photodetector 104 in the system 100 of FIG. 1. FIG. 3 shows a top-down view of the photodetector 104. As seen in FIG. 3, the photodetector 104 includes the substrate 106 and the absorption region 108. Generally, the absorption region 108 has a rectangular shape, and the substrate 106 has a portion with a rectangular shape and a portion with a triangular shape (which altogether may also be referred to as a trapezoidal shape).

The substrate 106 includes a first portion 302. As seen in FIG. 3, the first portion 302 includes a tapered edge 304 that causes the first portion 302 to be triangular in shape. Although, the tapered edge 304 is shown as a straight edge, it is contemplated that the tapered edge 304 may include curvature. For example, the tapered edge 304 may include portions with a convex curvature and/or a concave curvature. Additionally, the substrate 106 includes a second portion 306 that is rectangular in shape. The first portion 302 is coupled to the second portion 306 and may be made of the same material as the second portion 306 (e.g., silicon). In some embodiments, the first portion 302 is separate from the second portion 306 (e.g., has a gap filled with oxide between the first portion 302 and the second portion 306).

The first portion 302 and the second portion 306 form an edge 308 of the substrate 106. Additionally, the second portion 306 forms an edge 310, an edge 312, and an edge 314. The first portion 302 forms the tapered edge 304, and the tapered edge 304 extends from the edge 308 to the edge 314. In some embodiments, the second portion 306 does not form the edge 314, and the tapered edge 304 extends from the edge 308 to the edge 312. In the example of FIG. 3, the edge 308 forms a left side of the substrate 106, the edge 310 forms a bottom side of the substrate 106, the edge 312 forms a right side of the substrate 106 (e.g., opposite the left side), and the tapered edge 304 and the edge 314 form an upper side of the substrate 106 (e.g., opposite the bottom side).

The absorption region 108 is positioned on the substrate 106. As discussed previously, the absorption region 108 includes a material (e.g., germanium) that absorbs an optical signal (e.g., light) to form electron-hole pairs. These electrons and holes are then separated to produce an electrical signal (e.g., an electric current). As seen in FIG. 3, the absorption region has edges 316, 318, 320, and 322. The edge 316 forms an upper side of the absorption region 108. The edge 318 forms a left side of the absorption region 108. The edge 320 forms a bottom side of the absorption region 108. The edge 322 forms a right side of the absorption region 108. The edges 316 and 320 extend along a length of the absorption region 108, and the edges 318 and 322 extend along a width of the absorption region 108. The edges 316 and 320 may be longer than the edges 318 and 322. In some embodiments, the absorption region 108 is positioned or the first portion 302 is shaped such that the first portion 302 extends across the length of the absorption region 108.

In operation, the optical signal 110 enters the substrate 106 at the edge 308. For example, the optical signal 110 may enter the substrate 106 at a portion of the edge 308 formed by the first portion 302. The optical signal 110 may then travel through the first portion 302 of the substrate 106, and the tapered edge 304 may direct the optical signal 110 towards the second portion 306. The absorption region 108 then absorbs the optical signal 110 in the second portion 306. Specifically, as seen in FIG. 3, the optical signal 110 is directed (e.g., funneled) by the tapered edge 304 across the length of the absorption region 108. As a result, the absorption region 108 absorbs the optical signal 110 across the edge 316 or the length of the absorption region 108, which may allow the photodetector 104 to provide improved bandwidth and return loss relative to existing photodetectors.

In some embodiments, the photodetector 104 includes metal contacts in the substrate 106 and/or the absorption region 108. The metal contacts direct the electrical signal produced by the absorption region 108 away from the photodetector. For example, the metal contacts may allow an electric current produced by the absorption region 108 to exit the photodetector 104. One set of metal contacts may be formed along the edge 310 of the substrate 106, and another set of metal contacts may be formed on or beneath the absorption region 108. Although the metal contacts may cause an increase in resistance relative to existing photodetectors, this resistance increase may be mitigated by bringing the first set of metal contacts along the edge 310 closer to the absorption region 108 and by increasing the doping level of the metal contacts.

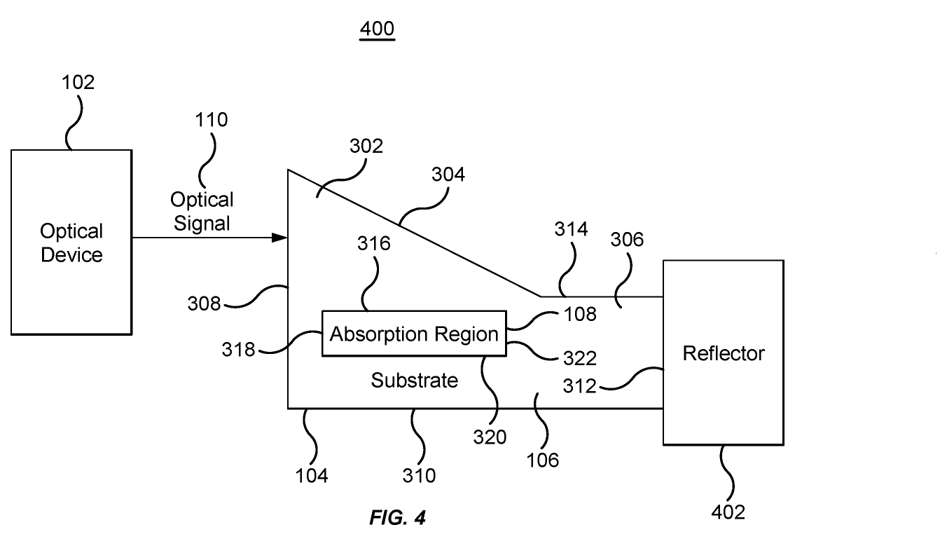

FIG. 4 illustrates an example configuration 400 of the system 100 of FIG. 1. As seen in FIG. 4, the configuration 400 includes the optical device 102, the photodetector 104, and a reflector 402. The reflector 402 is made of any material (e.g., silicon) that reflects optical signals. For example, the reflector 402 may be a Bragg device or may include a Sagnac loop. The reflector 402 is coupled to the photodetector 104 at the edge 312 of the substrate 106.

The optical device 102 directs the optical signal 110 to the photodetector 104. The optical signal 110 enters the first portion 302 of the substrate 106 at the edge 308. The tapered edge 304 then directs the optical signal 110 to the second portion 306 of the substrate 106. The absorption region 108 then absorbs the optical signal 110 and produces an electrical signal. If a portion of the optical signal 110 is not absorbed by the absorption region 108, then the substrate 106 directs the portion of the optical signal 110 to the reflector 402. The reflector 402 may then reflect the portion of the optical signal 110 back towards the substrate 106, and the absorption region 108 may have another opportunity to absorb the portion of the optical signal 110. As a result, the reflector 402 may reduce the likelihood that portions of the optical signal 110 are not absorbed.

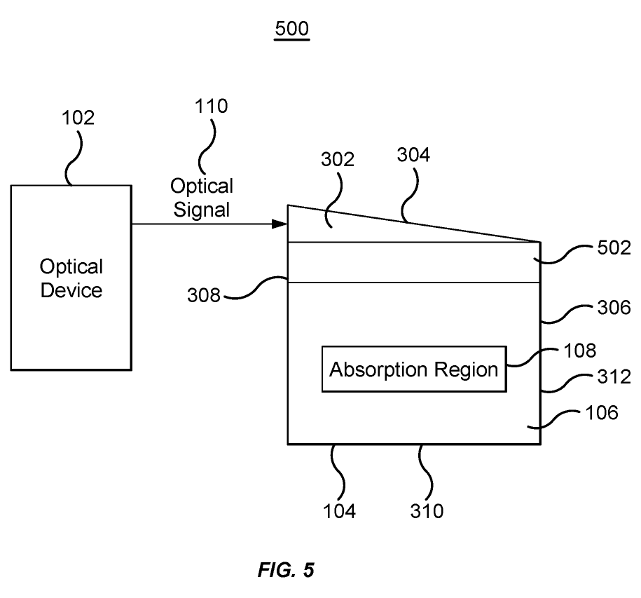

FIG. 5 illustrates an example configuration 500 of the system 100 of FIG. 1. As seen in FIG. 5, the configuration 500 includes the optical device 102 and the photodetector 104. The substrate 106 of the photodetector 104 includes the first portion 302 and the second portion 306. The first portion 302 is separate from the second portion 306. For example, the first portion 302 may not be directly coupled to the second portion 306. Instead, a gap 502 may be positioned between the first portion 302 and the second portion 306. In some embodiments, an oxide (e.g., silicon dioxide) fills the gap 502, and the gap 502 may have a width of around 100 nanometers (nm). As a result, the edge 308 is formed by the first portion 302, the gap 502 (or the oxide filling the gap 502), and the second portion 306. Additionally, the tapered edge 304 extends from the edge 308 to the edge 312. In certain embodiments, the configuration 500 provides increased responsivity relative to other configurations.

The optical device 102 directs the optical signal 110 to the photodetector 104. The optical signal 110 enters the first portion 302 of the substrate 106 at the edge 308. The tapered edge 304 directs the optical signal 110 towards the second portion 306. The optical signal 110 travels through the gap 502 and into the second portion 306. The absorption region 108 then absorbs the optical signal 110 to produce the electrical signal.

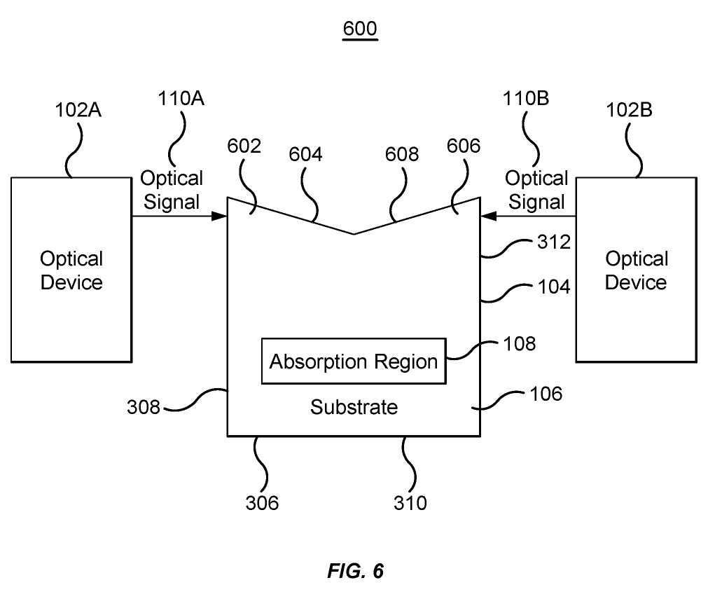

FIG. 6 illustrates an example configuration 600 of the system 100 of FIG. 1. As seen in FIG. 6, the configuration 600 includes an optical device 102A, the photodetector 104, and an optical device 102B. The optical device 102A and the optical device 102B (which may be the optical device 102 shown in FIG. 1) may be positioned on opposite sides of the photodetector 104. The photodetector 104 includes a first portion 602, the second portion 306, and a third portion 606. The first portion 602 forms a tapered edge 604, and the third portion 606 forms a tapered edge 608. The first portion 602 and the third portion 606 are positioned on the second portion 306 such that the tapered edges 604 and 608 form an upper side of the substrate 106. Additionally, the tapered edges 604 and 608 extend in different directions and into each other. As a result, the edge 308 is formed by the first portion 602 and the second portion 306, and the edge 312 is formed by the third portion 606 and the second portion 306.

The optical device 102A and the optical device 102B may produce the optical signals 110A and 110B using multiple input optical signals. For example, the optical device 102A may use a first input optical signal and a second input optical signal to produce the optical signal 110A, and the optical device 102B may use a third input optical signal and a fourth input optical signal to produce the optical signal 110B. The optical device 102A directs the optical signal 110A to the photodetector 104, and the optical device 102B directs the optical signal 110B to the photodetector 104. The optical signals 110A and 110B may travel in opposite directions.

The optical signal 110A enters the first portion 602 at the edge 308, and the optical signal 110B enters the third portion 606 at the edge 312. The tapered edge 604 directs the optical signal 110A to the second portion 306, and the tapered edge 608 directs the optical signal 110B to the second portion 306. The absorption region 108 may extend beneath the first portion 602 and the third portion 606. The absorption region 108 in the configuration 600 may have a longer length than the absorption region in other configurations, which may reduce bleed through of the optical signals 110A and 110B. The absorption region 108 may absorb the optical signal 110A and the optical signal 110B and produce one or more electrical signals. For example, the absorption region 108 may produce a first electrical signal using the optical signal 110A and a second electrical signal using the optical signal 110B. The absorption region 108 may combine these electrical signal into a single electrical signal at the output of the photodetector 104.

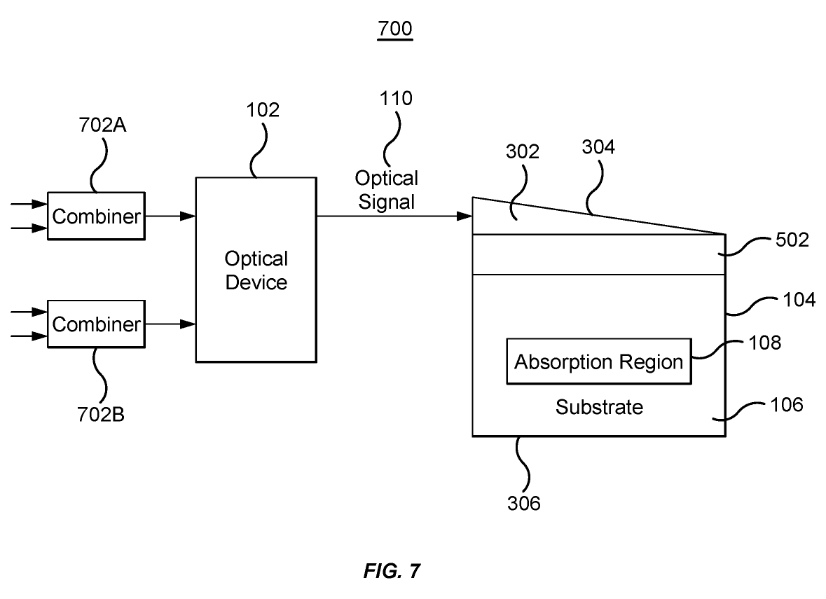

FIG. 7 illustrates an example configuration 700 of the system 100 of FIG. 1. As seen in FIG. 7, the configuration 700 includes a combiner 702A, a combiner 702B, the optical device 102, and the photodetector 104. Generally, the combiners 702A and 702B produce the input optical signals for the optical device 102. The optical device 102 then produces the optical signal 110 using these input optical signals.

The combiners 702A and 702B may be optical devices (e.g., Bragg gratings) that combine optical signals of different wavelengths into a single output optical signal. The combiners 702A and 702B then direct these output optical signals to the optical device 102. The optical device 102 produces the optical signal 110 using these output optical signals and directs the optical signal 110 to the photodetector 104. In this manner, the configuration 700 operates on at least four input signals to the optical system.

Like previous configurations, the optical signal 110 enters the first portion 302 of the substrate 106, and the tapered edge 304 directs the optical signal 110 to the second portion 306 of the substrate 106. There may be a gap 502 between the first portion 302 and the second portion 306 through which the optical signal 110 travels. The absorption region 108 then absorbs the optical signal 110 and produces an electrical signal.

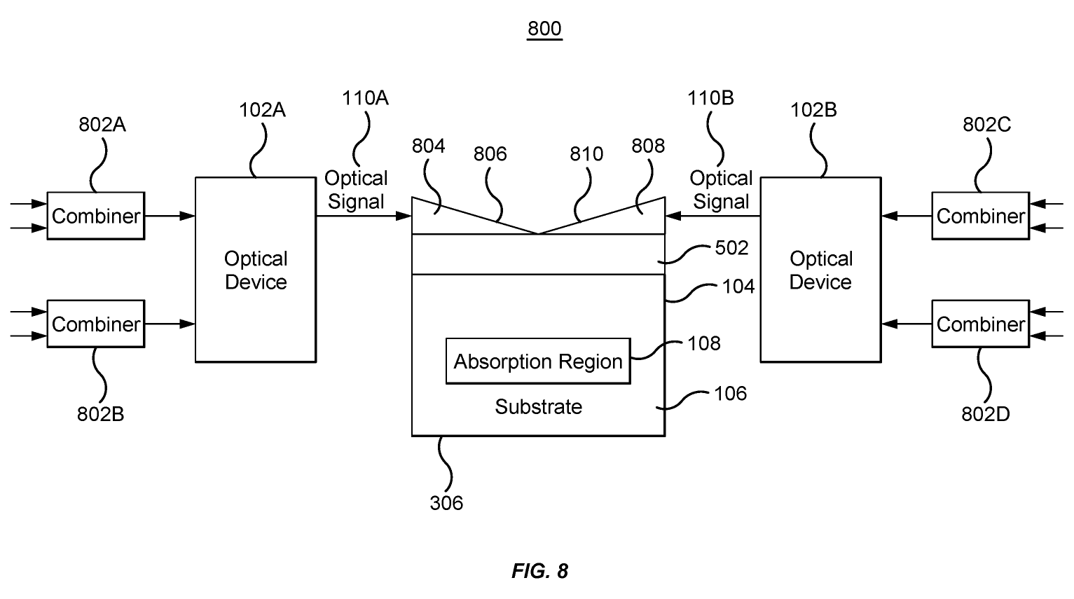

FIG. 8 illustrates an example configuration 800 of the system 100 of FIG. 1. As seen in FIG. 8, the configuration 800 includes combiners 802A, 802B, 802C, and 802D, optical devices 102A and 102B, and the photodetector 104. Generally, the combiners 802A, 802B, 802C, and 802D produce the input optical signals for the optical devices 102A and 102B. The optical devices 102A and 102B then produce the optical signals 110A and 110B using these input optical signals.

The combiners 802A, 802B, 80C, and 802D may be optical devices (e.g., Bragg gratings) that combine optical signals of different wavelengths into a single output optical signal. The combiners 802A, 802B, 80C, and 802D then direct these output optical signals to the optical devices 102A and 102B. The combiners 802A and 802B direct output optical signals to the optical device 102A, and the combiners 802C and 802D direct output optical signals to the optical device 102B. The optical devices 102A and 102B produce the optical signals 110A and 110B using these output optical signals and direct the optical signals 110A and 110B to the photodetector 104. The combiners 802A and 802B and the optical device 102A are positioned on one side of the photodetector 104, and the combiners 802C and 802D and the optical device 102B are positioned on an opposite side of the photodetector 104. The optical device 102A directs the optical signal 110A in a direction towards the photodetector 104, and the optical device 102B directs the optical signal 110B in an opposite direction towards the photodetector 104. In this manner, the configuration 800 operates on at least eight input signals to the optical system.

The photodetector 104 includes the substrate 106 and the absorption region 108 positioned on the substrate 106. The substrate 106 includes a first portion 804 with a tapered edge 806, the second portion 306, and a third portion 808 with a tapered edge 810. The absorption region is positioned on the second portion 306. The first portion 804 and the third portion 808 are positioned adjacent to each other and separate from the second portion 306. The tapered edges 806 and 810 extend towards each other. In some embodiments, the first portion 804 and the third portion 808 are coupled directly to the second portion 306 instead of being separate from the second portion 306.

The optical signal 110A enters the first portion 804 of the substrate 106, and the optical signal 110B enters the third portion 808 of the substrate 106. The tapered edge 806 directs the optical signal 110A to the second portion 306 of the substrate 106, and the tapered edges 810 directs the optical signal 110B to the second portion 306 of the substrate 106. The absorption region 108 then absorbs the optical signals 110A and 110B and produces one or more electrical signals.

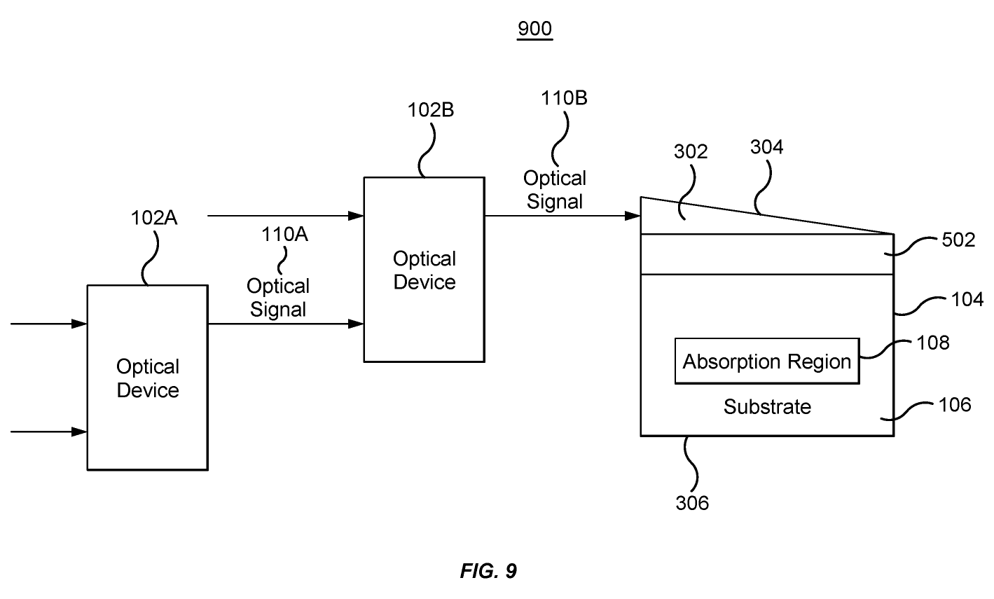

FIG. 9 illustrates an example configuration 900 of the system 100 of FIG. 1. As seen in FIG. 9, the configuration 900 includes an optical device 102A, an optical device 102B, and the photodetector 104. Generally, the optical devices 102A and 102B are cascaded and may be two-mode multiplexers, two-mode Ys, or polarization splitter rotators. The photodetector 104 includes the substrate 106 and the absorption region 108. The substrate 106 includes the first portion 302 and the second portion 306 separated by the gap 502. The absorption region 108 is positioned on the second portion 306.

The optical device 102A receives two input optical signals and produces an optical signal 110A. The optical device 102B receives the optical signal 110A and another input optical signal and produces an optical signal 110B. The optical device 102B then directs the optical signal 110B to the first portion 302 of the substrate 106. The tapered edge 304 directs the optical signal 110B through the gap 502 and to the second portion 306. The absorption region 108 then absorbs the optical signal 110B and produces an electrical signal. In this manner, the configuration 900 operates on at least three input signals to the optical system.

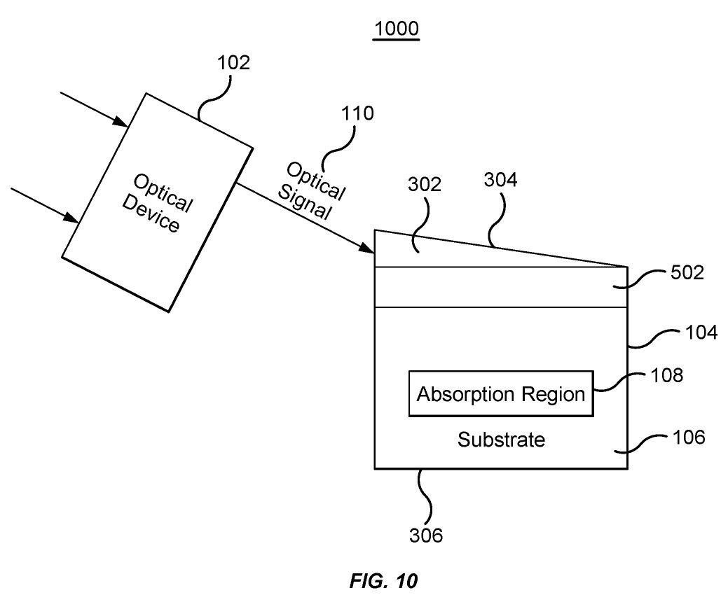

FIG. 10 illustrates an example configuration 1000 of the system 100 of FIG. 1. As seen in FIG. 10, the configuration 1000 includes the optical device 102 and the photodetector 104. Generally, the optical device 102 and the photodetector 104 are angled or offset relative to each other (e.g., such that the optical device 102 directs the optical signal 110 towards the photodetector 104 in a direction that is not parallel or non-parallel with the absorption region 108). In certain embodiments, this arrangement of the optical device 102 and the photodetector 104 reduces return loss and improves responsivity relative to other configurations.

The optical device 102 directs the optical signal 110 to the first portion 302 of the substrate 106. The tapered edge 304 directs the optical signal 110 through the gap 502 and to the second portion 306 of the substrate 106. The absorption region 108 then absorbs the optical signal 110 and produces the electrical signal.

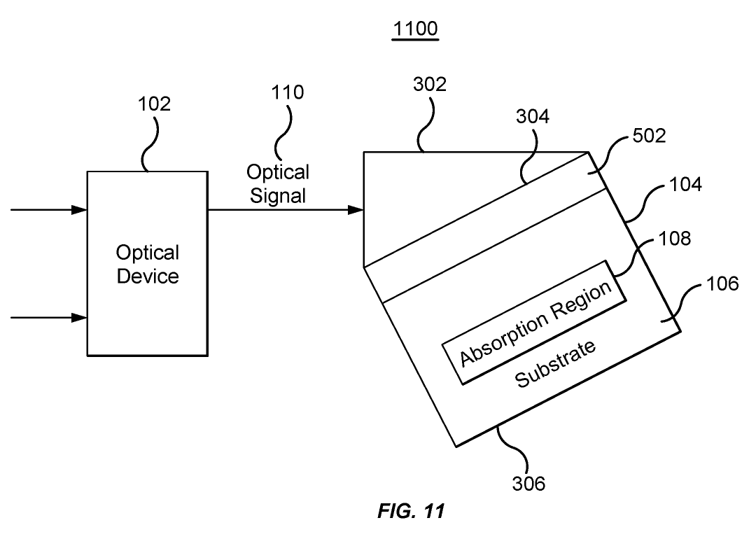

FIG. 11 illustrates an example configuration 1100 of the system 100 of FIG. 1. As seen in FIG. 11, the configuration 1100 includes the optical device 102 and the photodetector 104. Generally, the optical device 102 and the photodetector 104 are angled or offset relative to each other (e.g., such that the optical device 102 directs the optical signal 110 towards the photodetector 104 in a direction that is not parallel or non-parallel with the absorption region 108). In the configuration 1100, the first portion 302 of the substrate 106 includes the tapered edge 304 as an inner edge along the gap 502 and/or the second portion 306 (as opposed to having the tapered edge 304 forming an upper side of the photodetector 104 as in other configurations). As a result, the first portion 302 provides a more optimal transition for the optical signal 110 entering the first portion 302 relative to other configurations.

The optical device 102 directs the optical signal 110 to the first portion 302 of the substrate 106. The tapered edge 304 directs the optical signal 110 through the gap 502 and to the second portion 306 of the substrate 106. The absorption region 108 then absorbs the optical signal 110 and produces the electrical signal.

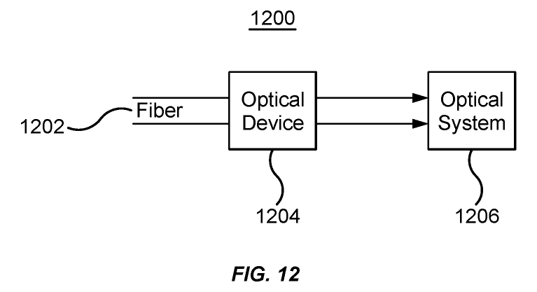

FIG. 12 illustrates an example configuration 1200 of the system 100 of FIG. 1. As seen in FIG. 12, the configuration 1200 includes a fiber 1202, an optical device 1204, and an optical system 1206. Generally, the configuration 1200 provides the input optical signals to the optical system 1206, which may include any of the configurations for the optical systems described above.

The fiber 1202 may carry one or more optical signals to the optical device 1204. The optical device 1204 may include any number of optical components. For example, the optical device 1204 may include an edge coupler and a polarization splitter rotator. As another example, the optical device 1204 may include a polarization splitting grating coupler, a fiber array unit based external mulstiplexer/demultiplexer, and one or more grating couplers. The optical device 1204 uses these optical components to use the optical signals carried by the fiber 1202 to produce the input optical signals for the optical system 1206. Generally, the optical device 1204 may be adjusted to produce any number of input optical signals for the optical system 1206. Additionally, the configuration 1200 may be adjusted to include any number of optical devices 1204 to provide any number of input optical signals for the optical system 1206. The optical system 1206 then produces one or more electrical signals using the input optical signals.

In some embodiments, the configuration 1200 includes a sub-micron photodetector with reduced receiver return loss, higher responsivity, and/or higher bandwidth than existing optical systems.

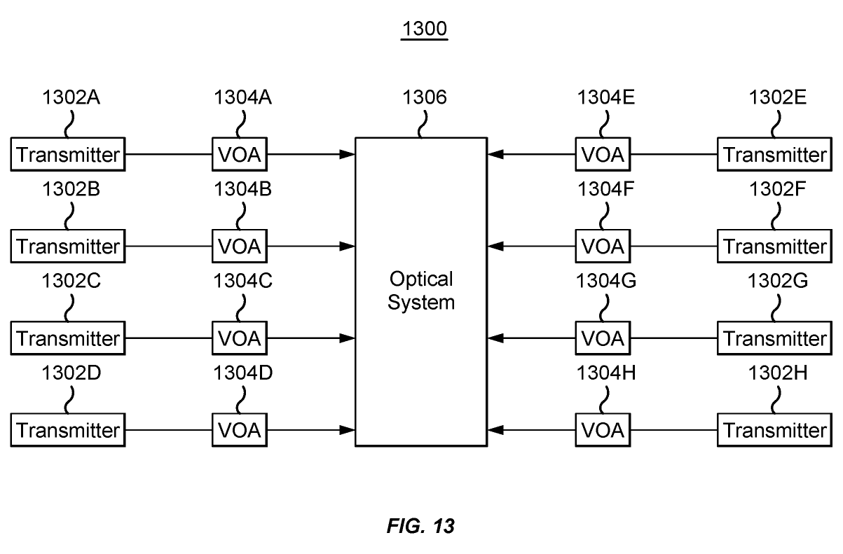

FIG. 13 illustrates an example configuration 1300 of the system 100 of FIG. 1. As seen in FIG. 13, the configuration 1300 includes multiple transmitters 1302A, 1302B, 1302C, 1302D, 1302E, 1302F, 1302G, and 1302H, multiple variable optical attenuators (VOAs) 1304A, 1304B, 1304C, 1304D, 1304E, 1304F, 1304G, and 1304H, and the optical system 1306. Generally, the transmitters 1302 and the VOAs 1304 provide input optical signals (e.g., eight input optical signals) to the optical system 1306, which may produce one or more electrical signals using the input optical signals. The number of transmitters 1302 and the number of VOAs 1304 may be adjusted to produce any number of input optical signals for any optical system or configuration. The optical system 1306 may include any of the configurations for the optical systems described above.

The transmitters 1302 produce optical signals. The VOAs 1304 function as switches that block or direct the optical signals from the transmitters 1302 to the optical system 1306. In the example of FIG. 13, the transmitter 1302A directs an optical signal to the VOA 1304A. The transmitter 1302B directs an optical signal to the VOA 1304B. The transmitter 1302C directs an optical signal to the VOA 1304C. The transmitter 1302D directs an optical signal to the VOA 1304D. The transmitter 1302E directs an optical signal to the VOA 1304E. The transmitter 1302E directs an optical signal to the VOA 1304E. The transmitter 1302E directs an optical signal to the VOA 1304E. The transmitter 1302E directs an optical signal to the VOA 1304E.

The VOA 1304A may block the optical signal from the transmitter 1302A or direct the optical signal to the optical system 1306. The VOA 1304B may block the optical signal from the transmitter 1302B or direct the optical signal to the optical system 1306. The VOA 1304C may block the optical signal from the transmitter 1302C or direct the optical signal to the optical system 1306. The VOA 1304D may block the optical signal from the transmitter 1302D or direct the optical signal to the optical system 1306. The VOA 1304E may block the optical signal from the transmitter 1302E or direct the optical signal to the optical system 1306. The VOA 1304F may block the optical signal from the transmitter 1302F or direct the optical signal to the optical system 1306. The VOA 1304G may block the optical signal from the transmitter 1302G or direct the optical signal to the optical system 1306. The VOA 1304H may block the optical signal from the transmitter 1302H or direct the optical signal to the optical system 1306. The optical system 1306 may then produce one or more electrical signals using the input optical signals directed to the optical system 1306.

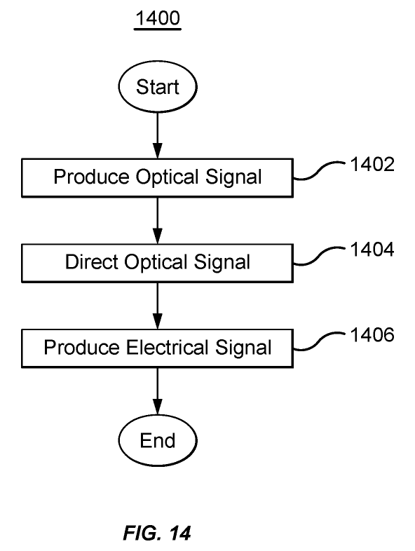

FIG. 14 is a flowchart of an example method 1400 performed by the system 100 of FIG. 1. In certain embodiments, different components of the optical system perform the steps of the method 1400. By performing the method 1400, the system provides improved bandwidth and communication speeds relative to existing systems. Additionally, the system may provide improved return loss, responsivity and power handling relative to existing systems.

At 1402, an optical device of the system produces an optical signal. The optical device may produce the optical signal using multiple input optical signals. The optical signal may include the modes of the input optical signals. For example, the optical device may be a two-mode multiplexer, a two-mode Y, or a polarization splitter rotator. The optical device may direct the optical signal to a photodetector.

At 1404, the photodetector directs the optical signal. The photodetector may include a substrate that includes a first portion and a second portion. The first portion may be coupled directly to the second portion, or the first portion may be separate from the second portion. The optical signal from the optical device enters the first portion of the substrate. The first portion includes a tapered edge that directs the optical signal in the first portion towards the second portion.

At 1406, the photodetector produces an electrical signal. The photodetector includes an absorption region (e.g., a germanium absorption region) that is positioned on the second portion. The absorption region may absorb the optical signal traveling through the second portion and produce the electrical signal proportional to the absorbed optical signal. Absorbing the optical signal may produce electron-hole pairs in the absorption region. The electrons and holes may then be separated (e.g., using an electric field) to produce the electrical signal. In some embodiments, the photodetector includes metal contacts that carry the electrical signal out of the photodetector.

In summary, the optical system 100 includes a photodetector 104 (e.g., a germanium photodetector or germanium photodiode). The photodetector 104 includes a substrate 106 and an absorption region 108 positioned on the substrate 106. The substrate 106 includes a tapered edge 304 that directs optical signals towards the absorption region 108, which may be rectangular in shape. The optical signals enter the absorption region 108 across a length of the absorption region 108, which may be longer than the width of the absorption region 108. The absorption region 108 then produces an electrical signal based on the optical signal.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when the elements of the embodiments are described in the form of "at least one of A and B, " or "at least one of A or B," it will be understood that embodiments including element A exclusively, including element B exclusively, and including A and B are each contemplated. Furthermore, although some embodiments disclosed herein may achieve advantages over other possible solutions or over prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to "the invention" shall not be construed as a generalization of any inventive subject matter disclosed herein and shall not be considered to be an element or limitation of the appended claims except where explicitly recited in a claim(s).

In view of the foregoing, the scope of the present disclosure is determined by the claims that follow.

We claim:

1. An optical system comprising:
a first optical device arranged to produce a first optical signal based on a first input optical signal and a second input optical signal;
a substrate comprising a first portion and a second portion, wherein the first portion comprises a first tapered edge arranged to direct the first optical signal to the second portion; and
an absorption region positioned on the second portion of the substrate, wherein the absorption region is arranged to produce a first electrical signal based on the first optical signal.

2. The optical system of claim 1, wherein the first optical device comprises at least one of a mode multiplexer, a two-mode y optical splitter, or a polarization splitter rotator.

3. The optical system of claim 1, wherein the first portion is separated from the second portion.

4. The optical system of claim 1, wherein the first portion extends across a length of the absorption region.

5. The optical system of claim 1, further comprising a second optical device arranged to produce a second optical signal based on a third input optical signal and a fourth input optical signal, wherein the substrate further comprises a third portion comprising a second tapered edge arranged to direct the second optical signal to the second portion, and wherein the absorption region is arranged to produce a second electrical signal based on the second optical signal.

6. The optical system of claim 5, wherein the first optical signal and the second optical signal are directed in opposite directions by the first optical device and the second optical device, respectively.

7. The optical system of claim 1, wherein the first optical device is arranged to direct the first optical signal in a direction non-parallel with the absorption region.

8. The optical system of claim 1, wherein the first optical signal includes a first mode and a second mode.

9. A method comprising:
producing, by a first optical device, a first optical signal based on a first input optical signal and a second input optical signal;
directing, by a first tapered edge of a first portion of a substrate, the first optical signal to a second portion of the substrate; and
producing, by an absorption region positioned on the second portion of the substrate, a first electrical signal based on the first optical signal.

10. The method of claim 9, wherein the first optical device comprises at least one of a mode multiplexer, a two-mode y optical splitter, or a polarization splitter rotator.

11. The method of claim 9, wherein the first portion is separated from the second portion.

12. The method of claim 9, wherein the first portion extends across a length of the absorption region.

13. The method of claim 9, further comprising:
producing, by a second optical device, a second optical signal based on a third input optical signal and a fourth input optical signal;
directing, by a second tapered edge of a third portion of the substrate, the second optical signal to the second portion; and
producing, by the absorption region, a second electrical signal based on the second optical signal.

14. The method of claim 13, wherein the first optical signal and the second optical signal are directed in opposite directions by the first optical device and the second optical device, respectively.

15. The method of claim 9, further comprising directing, by the first optical device, the first optical signal in a direction non-parallel with the absorption region.

16. The method of claim 9, wherein the first optical signal includes a first mode and a second mode.

17. An optical system comprising:
an optical multiplexer arranged to produce an optical signal based on a first input optical signal and a second input optical signal; and
a photodetector comprising:
a substrate comprising a first portion and a second portion, wherein the first portion comprises a first tapered edge arranged to direct the optical signal to the second portion; and
an absorption region positioned on the second portion of the substrate, wherein the absorption region is arranged to produce a first electrical signal based on the optical signal.

18. The optical system of claim 17, wherein the first portion is separated from the second portion.

19. The optical system of claim 17, wherein the first portion extends across a length of the absorption region.

20. The optical system of claim 17, wherein the optical multiplexer is arranged to direct the optical signal in a direction non-parallel with the absorption region.
